(19) United States
(12) Patent Application Publication
(10) Pub. No.: US 2015/0375106 A1
(43) Pub. Date: Dec. 31, 2015

(54) Implementing user motion games

(71) Applicant: Huan Liu, Sunnyvale, CA (US)

(72) Inventor: Huan Liu, Sunnyvale, CA (US)

(21) Appl. No.: 14/292,434

(22) Filed: May 30, 2014

Related U.S. Application Data
(60) Provisional application No. 61/832,968, filed on Jun. 10, 2013.

(51) Int. Cl. A63F 13/211; A63F 13/355

(52) U.S. Cl. CPC A63F 13/211; A63F 13/355

(57) ABSTRACT

A system and method for providing a user-motion game, comprising:
one or more motion sensors that capture motion of a user to yield user motion data;
a processor configured to process the motion data to compare said user motion data with demonstration motion data, and to compute a user score; and
a transmitter configured to wirelessly communicate with a video display device to display a video signal corresponding to said demonstration motion data.

### CROSS REFERENCE TO RELATED APPLICATIONS

This application is related to U.S. Provisional application No. 61/832,968, filed Jun. 10, 2013, and claims priority thereto. U.S. Provisional application No. 61/832,968 is hereby incorporated by reference in its entirety.

### FEDERALLY SPONSORED RESEARCH

Not Applicable

### SEQUENCE LISTING OR PROGRAM

Not Applicable

### BACKGROUND

Videos which may be used to learn or practice user-motion elements include: exercise videos, dance videos, sports training videos, as a partial list. By way of example, a common form of exercise is for a person to follow along with a workout routine, by listening to the voice instructions and seeing the movements as given by an instructor. An example is Zumba, where a fitness instructor performs a dance-inspired workout routine, and many students follow along to mimic the instructor's movement. A drawback of this type of exercise is that a person has to be physically at the same location as the instructor at the same time, for example, by joining a pre-scheduled fitness class. This unfortunately is an inconvenience for busy professionals who want to exercise whenever they have time at whatever place they are currently at.

A solution to the inconvenience problem is fitness videos. Instructors record the fitness routines on videos and then students watch the videos at their convenience to mimic the motion. There are drawbacks to this solution. It is difficult to make the workout session fun. In a group environment, there are many students performing the same routine at the same time. The competitive spirit makes it easy for a person to stick through the workout routine. Some user motion games such as dance or fitness games attempt to provide some of the benefits of groups. It is known to use electronic devices to sense the person's movement. An example is the Wii gaming platform. A number of games were introduced on the Wii platform aimed at tracking a person's motion while he/she is performing the workout routine. Unfortunately, a drawback of the Wii gaming platform is that it is not portable. A gaming platform is typically much bulky to be carried around, especially when the user is traveling. Furthermore, they are connected to a TV through a physical wire, the fixed wiring connection to a TV screen makes it cumbersome to re-connect to a different TV screen, for example, when the user wants to play the game in a different room or when the user is traveling.

### SUMMARY

Disclosed herein is a system and method for providing a user motion game, comprising:

one or more motion sensors that capture motion of a user to yield user motion data;

a processor configured to process the motion data to compare said user motion data with demonstration motion data, and to compute a user score; and

a transmitter configured to wirelessly communicate with a video display device to display a video corresponding to said demonstration motion data

### BRIEF DESCRIPTION OF THE DRAWINGS

The disclosure can be better understood with reference to the following drawings and description. The components in the figures are not necessarily to scale, emphasis instead being placed upon illustrating the principles of the invention. Moreover, in the figures, like referenced numerals designate corresponding parts or elements throughout the different views.

FIG. 1 is a block diagram illustrating elements of a system implementing a method for playing follow-along motion games.

FIG. 2 is a block diagram showing details of a device capable of capturing a user's motion and processing user motion data.

FIG. 3 is a block diagram illustrating an alternative embodiment where the video display device is a general purpose computer.

FIG. 4 is a block diagram illustrating an alternative embodiment where motion sensors and the processor reside in separate devices.

FIG. 5 is a block diagram illustrating an alternative embodiment where demonstration motion data and demonstration video are stored on a cloud server.

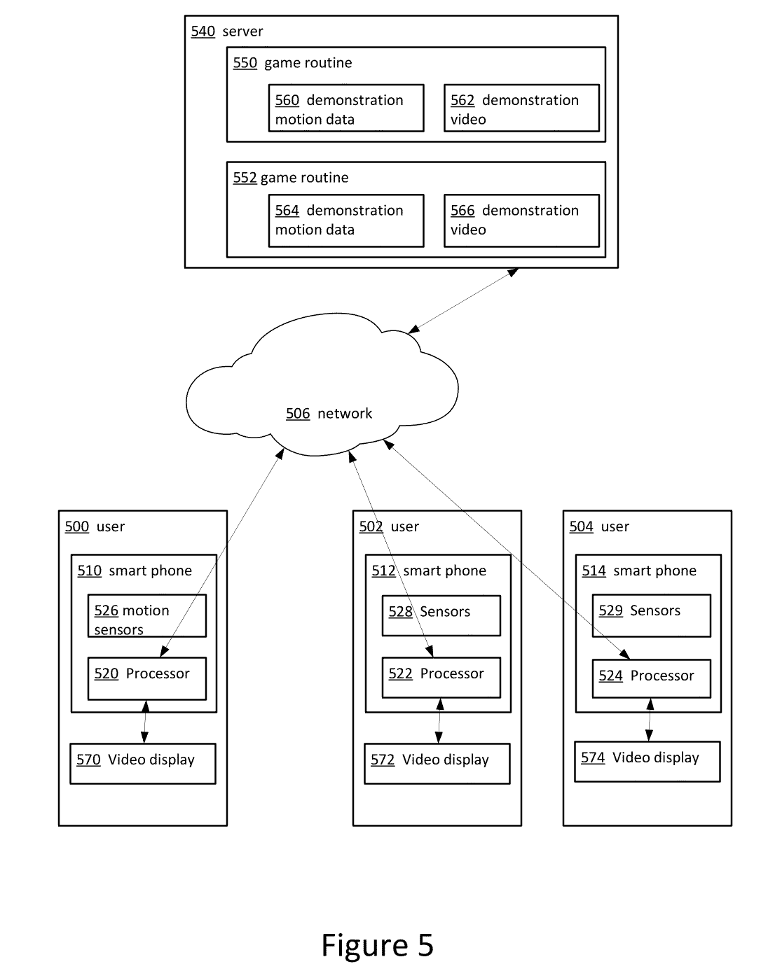

FIG. 6 is a flow diagram showing how a user play a user motion game according to an embodiment.

FIG. 7 shows a block diagram of how an instructor can create new game routines, creating both demonstration motion data and demonstration video.

FIG. 8 is a flow diagram showing how an instructor could create a new user motion routine according to an embodiment.

### DETAILED DESCRIPTION

Implementations are described hereinafter of a method and system for providing follow-along motion games utilizing videos such as: exercise videos, dance videos, sports training videos, etc. Implementations allow for unlimited number of game routines to be added, conveniently. Implementations can be carried by the user when traveling. Implementations can be played on a large number of different devices. Implementations track the users movements and determine if the user is doing the routine correctly.

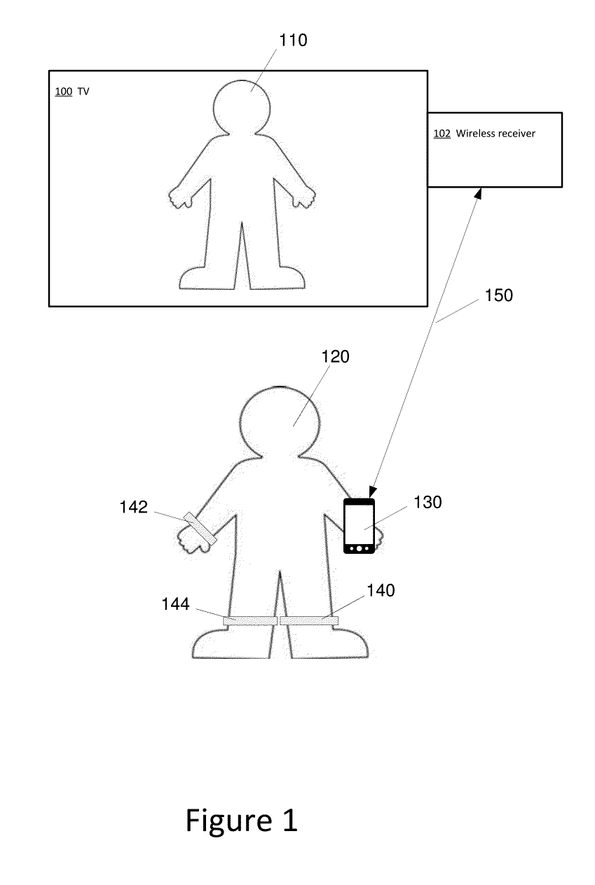

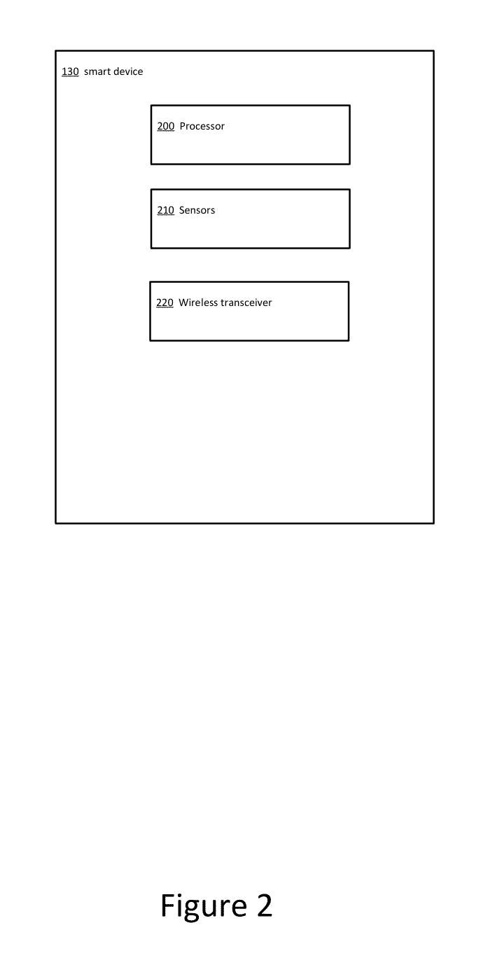

FIG. 1 is a block diagram illustrating elements of a system implementing a method for playing follow-along motion games. A user 120 carries a device 130, such as a smart phone, which is capable of sensing the user's movement, as well as displaying a demonstration video and computing a user score. FIG. 2 is a detailed block diagram of the device 130, which contains one or more motion sensors 210 capable of capturing motion of a user to yield user motion data, a processor 200 processing user motion data and is capable of computing a user score and a transceiver 220 capable of communicating with a video display device wirelessly to start a demonstration video. Types of motion sensors may include but are not limited to: accelerometer, gyroscope, magnetometer.

A TV 100 is connected to a wireless receiver 102, which is capable of receiving a video for displaying on the TV 100. The wireless receiver 102 may be built into the TV (which are often called smart TV), or it may be an external device that is connected to TV. Examples of such external wireless receivers 102 are Google Chromecast, Apple TV and Roku streaming stick. Device 130 communicates with the wireless receiver 102 through a wireless link 150, such as a WiFi link. Device 130 communicates with TV 100 to display a demonstration video. The demonstration video shows an instructor 110 performing a routine, such as a dance routine, for the user 120 to follow along. While user 120 is following along instructor 110, device 130 that she is carrying uses the built-in motion sensors 210 to capture the user's motion and generate a user motion data. In another embodiment, the TV 100 may be connected to cloud via a wired network connection, but through a wireless router, smart device 130 can wirelessly communicate with TV 100.

In an embodiment, the smart device 130 is a mobile phone carried in the user's hand. The smart phone 130 is a generic computing device that is capable of running a number of diverse and independent applications, such as a calculator, a weather reporting tool, a mp3 player, or a game. In addition, it is capable of communicating with a number of devices, such as different TV wirelessly or through a number of wireless receivers or through the cloud.

The wireless transmission to TV to display the demonstration video gives the user much greater flexibility and portability than is afforded by a game console. This contrasts with current systems such as Wii wherein the gaming console is connected to a display, generally a television display, using a hardwired connection. A drawback of the current systems is that they limit the video to a fixed display, such as a TV, and it takes considerable physical effort to switch to a different display device. For example, if a user wants to play a Wii game on a different TV, the user has to physically disconnect the video cable connecting the Wii console to the TV, and then reconnect it to another TV. The wireless transmission to TV increases the system cost, however, it provides higher flexibility and more convenience to the users.

Processor 200 is responsible for processing the user motion data and computing a user score. This processing includes comparing the user motion data with a demonstration motion data as the user follows along with the movements displayed on the demonstration video on TV 100. The demonstration motion data corresponds to the demonstration video, the demonstration motion data records movement of instructor 110. The processing may include computing a user score from the comparison.

In one embodiment, this processing first reads the output from the motion sensors at a predefined frequency, which is often referred to as the sampling frequency. Each output is often referred to as a sample. The samples from the sensors are stored in an array in the order that they were read. The processor then computes a similarity score between the sequence of samples from the motion sensors 210 with the sequence of samples from the demonstration motion data. In one embodiment, the similarity score is based on the cross-correlation between the two sequence of samples as defined in:

$$( f \times g ) [ n ] = {\sum }_{m = - ∞}^{∞} {f}^{*} [ m ] g [ m + n ]$$

where f is the samples from sensors 210, g is the samples from the demonstration motion data, and f* is the complex conjugate of f. n denotes the time lag between the two sequence of motion data. Both the demonstration motion data and user motion data are based on the movements displayed on the video, however, they may have a different time tag with respect to the start of the video. To tolerate the differences in time lag, n is varies in a limited range, for example, within a few seconds, and the maximum correlation value within that limited range is chosen to be the similarity score, which in turn is the basis for the user score. The cross-correlation is a value between 0 and 1. In order to show a score that is more meaningful to the user, the user score may be a function of the similarity score, for example, it could be a constant multiple of the similarity score.

f and g are often called time-domain signals. They represent the sequence of motion sensor reading in the time domain. Both can be transformed into other forms, such as into the frequency domain. In one embodiment, processing consists of transforming the motion data into other domains (for example, from time domain to frequency domain) and compute a similarity score and user score based on the signal similarity in that domain.

In one embodiment, the samples are separated into smaller segments, where each segment may only contain a few seconds worth of motion data. Processor 200 processes motion data segment by segment. It compares motion data in a segment from the user motion data with another segment from the demonstration motion data, and it computes a user score for that segment. The overall user score is the sum of the user score for each segment.

In one embodiment, a cross-correlation computation is computed first between all samples from the user motion data with all samples from the demonstration motion data to determine n, the offset between user motion data and demonstration motion data. Then, based on the offset n, processor 200 divides the samples into segments, so that a segment from the user motion data is aligned with a segment from the demonstration motion data that is offset n away.

In one embodiment, processor 200 first analyzes the user motion data to derive the user's motion. For example, based on a combination of gyroscope sensor and accelerometer sensor data, the processor can detect a sustained period of acceleration in a particular direction. The processor thus classifies this period of acceleration as one body movement. If, subsequently, the processor detects another period of sustained acceleration, but in the opposite direction, the processor classifies it as another movement, but in the opposite direction. The sequence of detected movements, along with their relative timing, are stored in an array. Similarly, processor 200 analyzes the demonstration motion data to derive a sequence of movements. The processor then compares the two sequence of movements, and reward user score if a user movement matches a movement in the demonstration motion data roughly at the same time.

In one embodiment, a user follows along the instructor on screen in a mirror fashion. For example, when the instructor moves her left arm left, the user follows by moving her right arm right. When processing, processor 200 inverts the user motion data to account for the mirror following. In another embodiment, processor 200 takes the absolute value of the similarity score to account for both positive similarity and negative similarity to account for both strict following and mirror following.

In one embodiment, a new user score is computed as new user motion data is generated, and the score is displayed on the video display device to give the users a real-time feedback on how well they are performing.

Besides the smart device 130, user 120 could be wearing a number of additional sensors 140, 142, 144 on other parts of her body, such as on her leg, body or wrist. Sensors 140, 142, 144 sense user's motion from different points of the body to yield more complete tracking of the user's movements. They transmit user motion data for other parts of the body to smart device 130 where it may be further processed. If demonstration motion data from the corresponding body position of the instructor is available, processor 200 also compares the user motion data for that body position with the demonstration motion data for that body position to compute a user score which is added to the total user score.

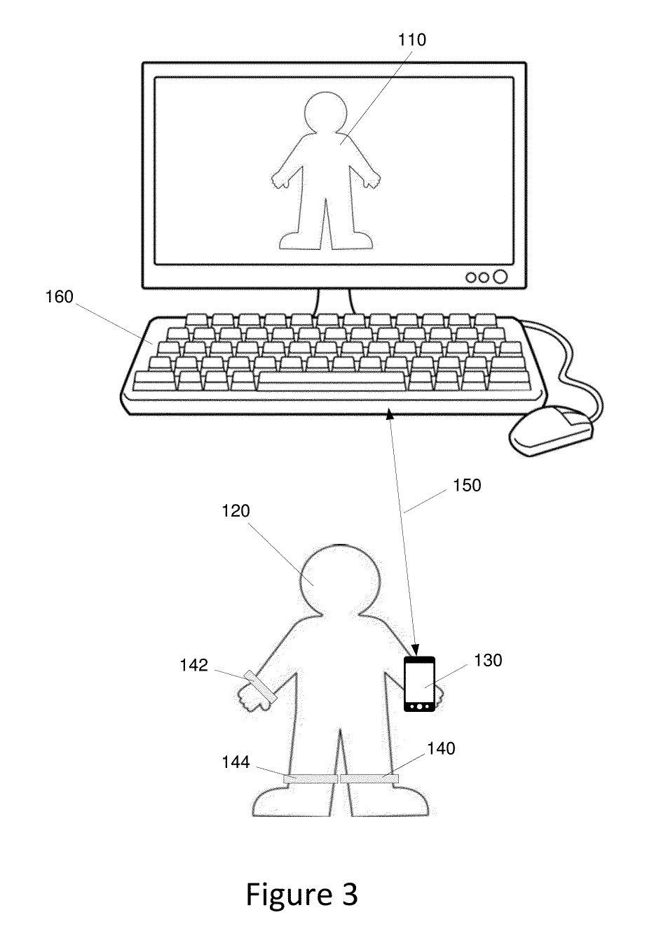

FIG. 3 shows an alternative embodiment where the TV screen could be simply a general purpose computer 160. Computer 160 may have a wireless connection, such as a WiFi connection, built-in already, thus, it can wirelessly communicate with the smart device 130. Computer 160 is capable of displaying the video on its monitor, thus alleviating the need for a separate TV or a separate wireless receiver. Alternatively, computer 160 may be connected to a cloud through a wired connection. Smart device 130 wirelessly communicates with the cloud, which in turn communicates with computer 160; thus, allow smart device 130 to communicate with computer 160.

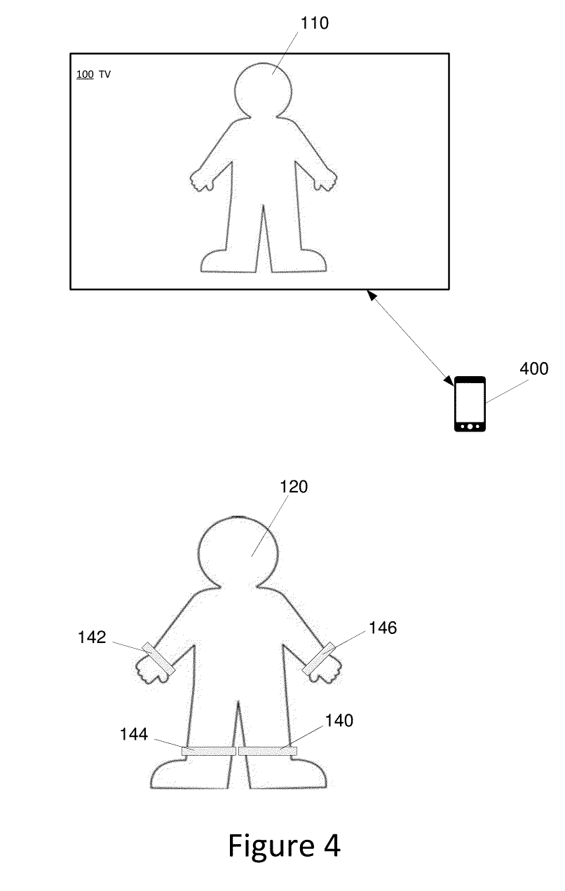

FIG. 4 is a block diagram illustrating yet another embodiment of the invention. In this embodiment, the processor which processes user motion data and computes the user score is contained in a portable device 400 separate from the at least one motion sensor 140, 142, 144, 146. The at least one motion sensor 140, 142, 144, 146 gathers user motion data which is wirelessly transmitted from the at least one motion sensor to the processor in device 400. In one embodiment, the at least one motion sensor may be included in a device worn on the user's hand or wrist or face, such as a smart watch, smart bracelet, or smart glass. Such a smart device is capable of connecting to variety of devices, such as a smart phone or a smart tablet, to transmit user motion data. Device 400 may be a mobile phone or a tablet computer, it is capable of running a variety of applications, such as calculator, weather report, or web browser. In addition, it is capable of connecting to a variety of devices, such as a variety of computers or TVs to display video, or a variety of sensor devices, such as smart watches, smart glasses or smart bracelet to collect user motion data. Device 400 is responsible for processing user motion data, as well as wirelessly transmit the demonstration video for display on the TV 100. In another embodiment, device 400 is capable of displaying the video itself, thus alleviating the need to wirelessly transmit the video to the TV 100.

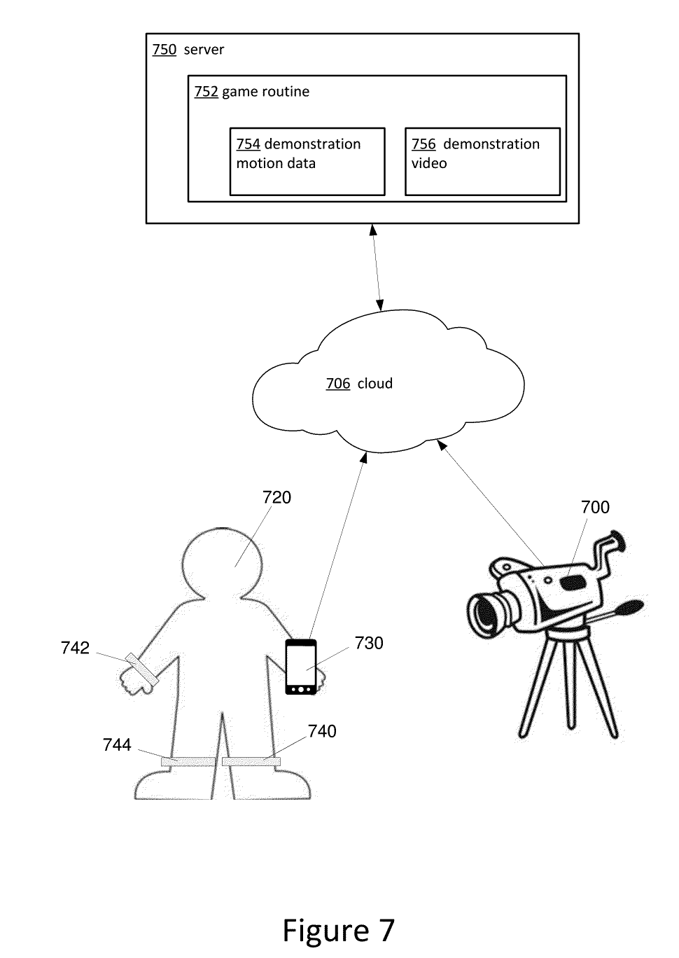

In an embodiment, the demonstration motion data and demonstration video corresponding to the demonstration motion data are stored on a cloud server, and are wirelessly imported to the processor. FIG. 7 shows a block diagram of such an embodiment with a number of users using smart phone devices. There are a number of users 500, 502, 504 using the systems, all of them possess a smart phone 510, 512, 514. The users who possess a smart phone 510, 512, 514 can play the user motion game.

There are a number of game routines 550, 552 stored in a backend server 540. Each workout routine 550, 552 consists of a demonstration motion data 560, 564 and a demonstration video 562, 566. The demonstration video 562, 566 shows an instructor performing a particular sequence of motions, such as performing a dance routine, potentially with a background music and the instructor's voice guidance on how to perform the routine correctly. The video 562,566 gives users visual demonstration to allow users to follow along with the instructor to perform the routine.

The smart phones 510, 512, 514 are connected to network 506 wirelessly. Server 540 is also connected to network 506; thus, smart phones 510, 512, 514 can communicate with server 540.

Users 500, 502, 504 are able to discover existing game routines 550, 552 stored on server 540. When the users 500, 502, 504 decide to play a game routine 550, 552, the smart phone 510, 512, 514 projects the demonstration video 562, 566 on to a video display 570, 572, 574 that the users can see. As described earlier, the video display 570, 572, 574 could be a TV monitor connected to Apple TV wireless receiver, and the smart phone 510, 512, 514 could use the AirPlay technology to project the video onto the TV monitor. In another embodiment, the video display 570, 572, 574 could simply be a computer running a web browser. Yet in another embodiment, the video display 570, 572, 574 could be a computer connected to the cloud directly. An advantage of this embodiment is that the computer does not have to be wirelessly connected to the smart phone 510, 512, 514 directly. Instead, it can be connected to the cloud through a wired network connection and then communicate with smart phone through the cloud. For example, a web browser running on the computer connects to the server 540 through a web socket. When the application 570, 572, 574 requests the video to be played, the sever 540 sends instruction through the web socket to the web browser to start playing the video. The video could be sent directly from the smart phone 510, 512, 514, or it could be downloaded from the cloud to video display 570, 572, 574.

While the demonstration video 562, 566 is shown on video display 570, 572, 574, the processor 520, 522, 524 uses the built-in motion sensors 526, 528, 529 to track the users' movement while the users follow along the demonstration video to perform the routine, and the processor 520, 522, 524 processes the collected user motion data including comparing with the demonstration motion data 560, 564, and computing a user score based on how much closer the users have performed the routine as compared to the instructor.

In one embodiment, the users 500, 502, 504 wait for other users to express a similar interest to perform the same routine. When enough users have expressed an interest, the server 540 informs the smart phone 510, 512, 514 for all interested users to start the routine. Smart phone 510, 512, 514 projects the demonstration video 562, 566 on video display 570, 572, 574, and use the built-in sensors 526, 528, 529 to collect users' movement. In one embodiment, the collected user motion data is compared with the demonstration motion data 560, 564, and a user score is computed, and a leaderboard is shown to all users showing who scored the highest in the competition. If users 500, 502, 504 are all in the same room, only one user may need to projects the demonstration video because all users can see the same demonstration video.

In one embodiment, the users 500, 502, 504 are rewarded points for completing the routine. The points could be used to redeem for rewards. In one embodiment, the application 520, 522, 524 asks the users to measure their heart rate, for example by placing his/her finger on the camera lens to measure the blood flow, and the points are only awarded when the measure heart rate exceeds a threshold.

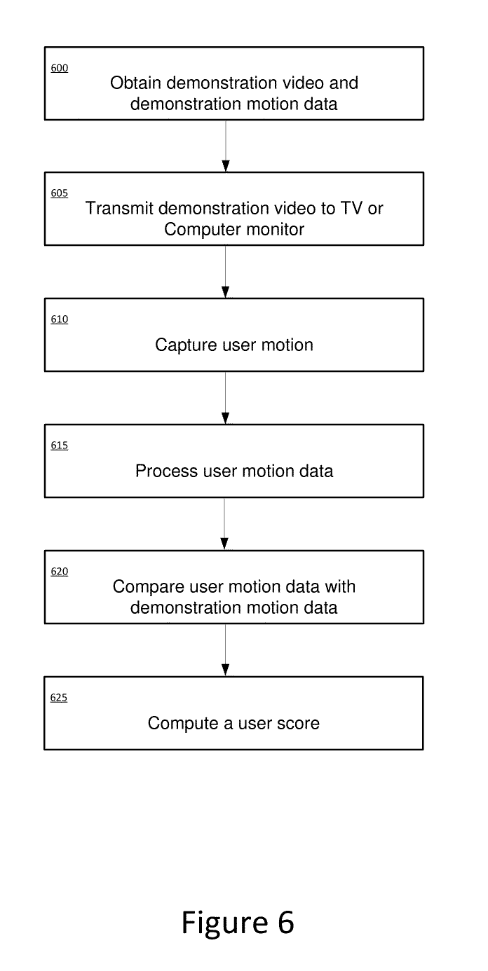

FIG. 6 is a flow diagram describing an embodiment of a method for playing a user motion game. In step 600, obtain demonstration motion data and the corresponding demonstration video. These may be obtained from a cloud server which stores demonstration video and demonstration motion data centrally.

In step 605, project demonstration video corresponding to the demonstration motion data to a video display device such as a television display or a computer display, to provide a demonstration video for user to see.

In step 610, capture the motion of a user following the demonstration video to yield user motion data, with one or more motion sensors. In an embodiment, a single motion sensor held in the user's hand as in a mobile phone provides one point user motion data. In an embodiment, a plurality of motion sensors are positioned at a plurality of locations on the user's body. In an embodiment, a camera may be used to obtain additional user motion data.

In step 615, process the user motion data with a processor. The processor may be integrated into a single device with the motion sensor, as in a smart mobile phone, or it may be in a portable device separate from the motion sensor(s). By way of example, the processor could reside in a smart mobile phone, and the motion sensor(s) could be worn on the user's body, as in a smart watch or smart bracelet worn on the wrist, or smart glass worn on the face. In this case, the user motion data would be wirelessly transmitted from the motion sensor(s) to the processor. One aspect of processing the user motion data is comparing it with the demonstration motion data (step 620). Additional processing steps maybe included, such as analyzing the sensor data to deduct the user movement (left, right, up or down). Another aspect of processing is computing a user score based on the comparison between the user motion data and the demonstration motion data. (step 625)

In addition to play the motion game, various implementations enable any instructor to create a new follow-along motion game routine. An example of such a game routine is a dance game routine. Only two pieces of equipment are required. An instructor first needs at least one smart device positioned on the instructor's body, a smart phone held in the hand being one example, including motion sensors such as accelerometer, gyroscope, or magnetometer, to record the instructor's movement during his/her performance of the routine. Second, the instructor needs a separate video recorder which can record the instructor's movement and any accompanying background music or other sounds such as narration during the routine. At the end of the routine, the instructor uploads both the sensor recording and the video recording to the cloud, so that other people can access the recorded routine. The video recording may be processed before uploading, for example, to replace the sound track on the video with the original music song track in order to improve the sound quality, as the sound quality as recorded by the video recorder may be lower than the original song track.

FIG. 7 illustrates a block diagram of how an instructor could create a new user-motion game. While performing a routine, an instructor 720 holds a smart device 730, such as a smart phone in her hand. The smart device 730 is wirelessly connected to server 750 through cloud 706. The smart device 730 uses its built-in motion sensors, such as an accelerometer, gyroscope, or magnetometer, to capture the instructor's movement and save the sensor data as demonstration motion data 754 associated with game routine 752 on server 750. In one embodiment, instructor 720 carries other motion sensors 740, 742, 744 on different parts of her body, such as on her foot, wrist, body, and the user motion data from those sensors are sent to smart device 730, which in turns saves the data on server 750. In another embodiment, sensors other than accelerometer, gyroscope and magnetometer can be used. For example, a camera could be aimed at the instructor, and an application can analyze the instructor's movement to derive the user motion data.

While instructor 720 is performing the routine, a camcorder 700 records her movements as a video. The video may be processed after the instructor finish the routine, for example, to add a different sound track or to adjust color, saturation etc., and it is uploaded to server 752 as the demonstration video 756 that is associated with the demonstration motion data 754 for the same game routine 752. In one embodiment, a web interface is present by the server 750 to facilitate uploading the demonstration video.

In one embodiment, camcorder 700 is simply a general purpose computer which has a Webcam. The computer is connected to server 750 through cloud 706. In one embodiment, smart device 730 informs computer 700 to start recording the video as soon as it starts to record the motion, and it informs computer 700 to stop recording video as soon as it ends recording the motion. Thus the demonstration video is more accurately synchronized with the demonstration motion data.

In an embodiment, the demonstration motion data and video signal corresponding to the demonstration motion data may be obtained from an external source such as youtube. By analyzing the demonstration video, a computer program could estimate the user motion data based on how the instructor is moving in the video

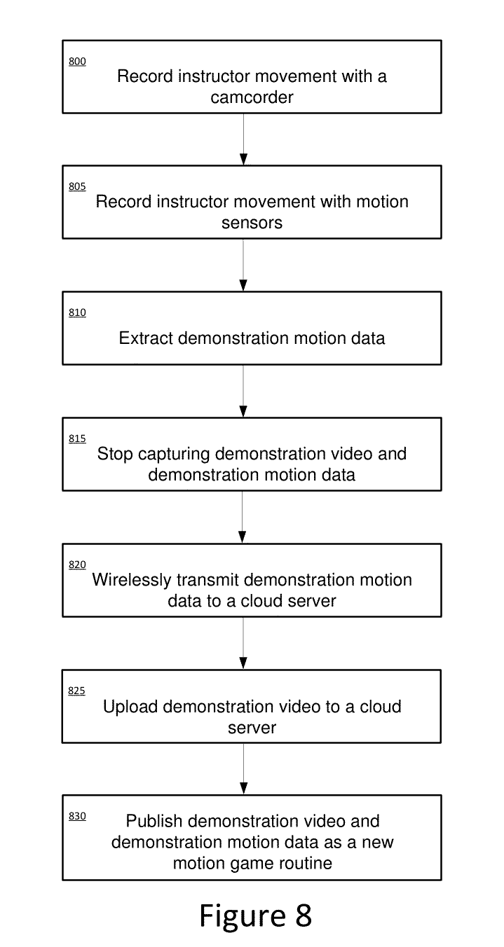

An aspect of some embodiments is the system and method capability of easily and interactively producing new user motion game routines, including new demonstration videos and new demonstration motion data. FIG. 8 is a flow diagram showing how an instructor could create a new user motion routine according to an embodiment.

In step 800, the instructor performs the demonstration routine while being recorded by a video camera, to provide a demonstration video. The video camera could be a stand alone camcorder, or it could be a webcam built into a computer.

In step 805, while performing the routine, at least one motion sensor is positioned on the instructor's body to gather demonstration motion data associated with the demonstration video signal. In an embodiment, the instructor is holding a smart mobile phone including motion sensor during performance of the routine.

In step 810, the demonstration motion data is automatically extracted by the software resident on a processor, utilizing the output of the motion sensor(s). In an embodiment, the processor and motion sensor(s) are integrated into a single device, such as a smart mobile phone. The automatic extraction of the demonstration motion data is in contrast to some systems, where motion data is manually extracted. It is expected that filtering may be added to the software to automatically filter out low amplitude or high frequency noise signals which could skew results. Manually extracting motion data is another way of filtering out extraneous noise, but is time consuming and costly. The start of the demonstration motion data is roughly aligned with the start of the demonstration video signal. This alignment can be achieved manually. For example, as soon as the video camera is started to record in step 800, the user informs the software on the processor to start capturing the demonstration motion data. Alternatively, the alignment could be achieved automatically. For example, the processor programmatically informs the video camera to start recording, while starting demonstration motion data capture at the same time.

In step 815, the capturing of the demonstration video signal and the capturing of the demonstration motion data are stopped.

In step 820, the demonstration motion data are wirelessly transmitted to a cloud server.

In step 825, the associated demonstration video is transmitted to a cloud server. The user could upload the video captured in the camera directly to the cloud server, or the user may process the captured video first, for example, to add new sound track, to adjust the video (crop, color correction etc.), and then upload the processed video to a cloud server.

In step 830, the demonstration video and the associated demonstration motion data are published and shared with users. A library of demonstration videos and associated motion data can be stored on the server.

In one embodiment, the users follow along a live instructor to perform a routine instead of following along a recorded demonstration video. The demonstration motion data is streamed to server as it is captured while the instructor is performing the routine, and the demonstration video may not be created because the instructor can demonstrate to the users directly, for example, while in person when they are at the same physical location. The users capture their motion data at the same time as the instructor is demonstrating the movement, and a processor computes a user score in real-time by comparing the user motion data with the streamed demonstration motion data.

In one embodiment, users may form teams to facilitate competition. In another embodiment, users may form friendship as facilitated by the server. A user can view his/her teammates' or friends' activities, such as the routine they performed or published recently, and their histories, such as their weight or heart rate trend, subject to the privacy constraints as specified by the users.

In one embodiment, an employer could form a group, where only verified employees could join the group. The employer may sponsor rewards that the employees could earn using the earned points. The admin for the employer would have a separate admin interface presented by server. The interface contains various statistics about the employees in the group, such as the average exercise time, the percentage who has a healthy cardiovascular system, or the percentage of people who are in the recommended weight range.

Reference has been made in detail to embodiments of the claimed subject matter, examples of which are illustrated in the accompanying drawings. While the claimed subject matter is described in conjunction with the embodiments, it will be understood that it is not intended to be limited to these embodiments. On the contrary, the claimed subject matter is intended to cover alternatives, modifications and equivalents, which may be included within the spirit and scope as defined by the appended claims.

Furthermore, in the detailed descriptions of embodiments of the claimed subject matter described herein, numerous specific details are set forth in order to provide a thorough understanding of the claimed subject matter. However, it will be recognized by one of ordinary skill in the art that the claimed subject matter may be practiced without these specific details. In other instances, well known methods, procedures, components, and circuits have not been described in detail as not to unnecessarily obscure aspects of the claimed subject matter.

Some portions of the detailed descriptions are presented in terms of procedures, steps, logic blocks, processing, and other symbolic representations of operations on data bits that can be performed on computer memory. These descriptions and representations are the means used by those skilled in the art to most effectively convey the substance of their work to others skilled in the art. A procedure, computer generated step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present claimed subject matter, discussions utilizing terms such as “storing,” “creating,” “protecting,” “receiving,” “encrypting,” “decrypting,” “destroying,” or the like, refer to the action and processes of a computer system or integrated circuit, or similar electronic computing device, including an embedded system, that manipulates and transforms data represented as physical (electronic) quantities within the computer system's registers and memories into other data similarly represented as physical quantities within the computer system memories or registers or other such information storage, transmission or display devices. The above disclosed embodiments of a method and system for providing user motion games utilizing videos such as: exercise videos, dance videos, sports training videos, etc., allow for increased flexibility and mobility for the user. Also enabled is the ability to easily create new demonstration videos for use in the games.

It is not expected that the claimed subject matter be restricted to the exact embodiments disclosed herein. Those skilled in the art will recognize that changes and modifications can be made without departing from the inventive concept. The invention should be construed in view of the claims.

1. A system for providing a user motion game, the system comprising:
one or more motion sensors that automatically capture motion of a user to yield user motion data;
a processor configured to process said user motion data, to compare said user motion data with demonstration motion data, and to compute a user score; and
a transmitter configured to wirelessly communicate with a video display device to display a video corresponding to said demonstration motion data.

2. The system of claim 1, wherein at least one motion sensor and said processor are integrated into a single device.

3. The system of claim 1, including a plurality of motion sensors positioned at a plurality of locations on the user's body.

4. The system of claim 1, wherein said motion sensor and said processor are integrated into a mobile phone to be carried by the user.

5. The system of claim 1, further comprising:
a portable device separate from said motion sensor, said portable device containing said processor;
a transmitter configured to wirelessly transmit said user motion data from said motion sensor to said processor; and
a receiver connected to said processor, said receiver configured to receive said user motion data from said motion sensor.

6. The system of claim 1, wherein at least one motion sensor tracks the user's hand movements.

7. The system of claim 5, wherein said at least one motion sensor is included in a device carried by the user's hand.

8. The system of claim 5, wherein said at least one motion sensor is included in a mobile phone.

9. The system of claim 5, wherein said at least one motion sensor is included in a device worn on the user's hand or wrist.

10. The system of claim 1, wherein said demonstration motion data and said video corresponding to said demonstration motion data are stored on a cloud server and said demonstration motion data is imported wirelessly to said processor and said video is wirelessly transmitted to the video display.

11. The system of claim 1, configured to:
obtain demonstration motion data and a video signal corresponding to said demonstration motion data;
wirelessly transmit said demonstration motion data and said video signal corresponding to said demonstration motion data to a cloud server; and
wirelessly import said demonstration motion data and said video signal corresponding to said demonstration motion data to said processor.

12. The system of claim 11, wherein said system is configured to input said demonstration motion data and a video signal corresponding to said demonstration motion data from an external source

13. The system of claim 11, wherein said system is configured to create said demonstration motion data and a video signal corresponding to said demonstration motion data.

14. The system of claim 13, configured such that said demonstration motion data is created in substantially the same way as the user motion data.

15. A method for providing a user motion game, the method comprising:
obtaining demonstration motion data and a video signal corresponding to said demonstration motion data;
wirelessly communicating with a video display device to display said video signal corresponding to said demonstration motion data to provide a demonstration video;
automatically capturing motion of a user following said demonstration video to yield user motion data, with one or more motion sensors;
processing said user motion data with a processor;
comparing said user motion data with demonstration motion data;
computing a user score;

[symbol]

16. The method of claim 15, wherein at least one motion sensor and said processor are integrated into a single device.

17. The method of claim 15, wherein said step of capturing motion of a user to yield user motion data utilizes a plurality of motion sensors positioned at a plurality of locations on the user's body.

18. The method of claim 15, wherein said step of capturing motion of a user to yield user motion data comprises said user carrying a mobile phone having said motion sensor and said processor integrated therein.

19. The method of claim 15, wherein said step of processing said user motion data with a processor utilizes a portable device separate from said motion sensor, said portable device containing said processor; and further including the step of wirelessly transmitting said user motion data from said motion sensor to said processor, said processor thereby receiving said user motion data from said motion sensor.

20. The method of claim 15, wherein said step of capturing motion of a user to yield user motion data comprises tracking the user's hand movements with at least one motion sensor.

21. The method of claim 19, wherein said step of capturing motion of a user to yield user motion data, comprises said user carrying a device including at least one motion sensor in the user's hand.

23. The method of claim 19, wherein said step of capturing motion of a user to yield user motion data, comprises said user wearing a device worn on the user's hand or wrist, wherein said at least one motion sensor is included in the device.

24. The method of claim 15, further comprising the steps of:
storing said demonstration motion data and said video signal corresponding to said demonstration motion data on a cloud server; and
wirelessly importing said demonstration motion data to said processor.

26. The method of claim 24, wherein said step of obtaining demonstration motion data and a video signal corresponding to said demonstration motion data comprises inputting said demonstration motion data and a video signal corresponding to said demonstration motion data from an external source.

27. The method of claim 24, wherein said step of obtaining demonstration motion data and a video signal corresponding to said demonstration motion data comprises;
creating said demonstration motion data and a video signal corresponding to said demonstration motion data, wherein said demonstration motion data is automatically extracted from said motion sensors; and
wirelessly transmitting said demonstration motion data and said video signal corresponding to said demonstration motion data to a cloud server.

28. The method of claim 27, wherein said step of creating demonstration motion data comprises capturing motion of a demonstrator to yield demonstration motion data, with one or more motion sensors, in substantially the same way as the method of yielding user motion data.

29. The method of claim 15, wherein the user motion game is a dance game.

30. A machine-readable storage medium storing computer-readable instructions that, when executed, cause a computer to perform the functions of:
capturing motion of a user obtained using one or more motion sensors to yield user motion data;
processing said user motion data with a processor;
comparing said user motion data with demonstration motion data;
computing a user score; and
wirelessly communicating with a video display device to display a video corresponding to said demonstration motion data.

31. The machine-readable storage medium storing computer-readable instructions of claim 30, that, when executed, further cause the computer to perform the functions of:
storing said demonstration motion data and said video signal corresponding to said demonstration motion data on a cloud server; and
wirelessly importing said demonstration motion data to said processor.

32. The machine-readable storage medium storing computer-readable instructions of claim 30, that, when executed, further cause the computer to perform the functions of:
obtaining demonstration motion data and a video signal corresponding to said demonstration motion data;
wirelessly transmitting said demonstration motion data and said video signal corresponding to said demonstration motion data to a cloud server; and
wirelessly importing said demonstration motion data to said processor.
